(19) United States
(12) Patent Application Publication
(10) Pub. No.: US 2015/0321352 A1
(43) Pub. Date: Nov. 12, 2015

(54) SIMULATION PLATFORM FOR VALIDATING A SOFTWARE AND MATERIAL ARCHITECTURE OF A ROBOT

(71) Applicants: UNIVERSITE BLAISE PASCAL - CLERMONT II, Clermont-Ferrand Cedex 1 (FR); CENTRE NATIONAL DE LA RECHERCHE SCIENTIFIQUE (C.N.R.S.), Paris (FR); INSTITUT NATIONAL DE RECHERCHE EN SCIENCES ET TECHNOLOGIES POUR L'ENVIRONNEMENT ET L'AGRICULTURE, Antony (FR)

(72) Inventors: Christophe DEBAIN, Saint saturnin (FR); Florent MALARTRE, Clermont Ferrand (FR); Pierre DELMAS, Clermont Ferrand (FR); Roland CHAPUIS, Issoire (FR)

(21) Appl. No.: 14/409,778

(22) PCT Filed: Jun. 19, 2013
(86) PCT No.: PCT/EP2013/062765

§ 371 Date: Dec. 19, 2014

(30) Foreign Application Priority Data
Jun. 20, 2012 (FR) 1255805

(51) Int. Cl. B25J 9/16

(52) U.S. Cl. CPC B25J 9/1671

(57) ABSTRACT

A simulation platform (110) including a calculating element suitable for executing the commands of a simulation program (300), includes: a module for configuring an environment into three dimensions (310); a module for simulating a response of a sensor of the robot (320, 330); and a module for simulating a dynamic of the robot (340). The simulation program includes, in addition, a time-sequencing module (350) including: a logic clock (410) outputting the current logic time; a sequencing scheme (400) associating a set of actions to be performed with each logic time; a sub-module for calling a simulation action (440) suitable for initiating the execution of a simulation action; and a sub-module for calling a reaction action of the robot (450), suitable for initiating the execution of a response action of the robot.

The present invention relates to a simulation platform for validating a software and hardware architecture of a robot.

In the following, by hardware and software architecture of a robot is meant a system implanted on board a robot and consisting of a hardware layer including a computer, one or several sensors and one or several actuators, and a software layer including an algorithm, the instructions of which are stored in memory in the computer so as to be executed by the latter.

The development cycle of the architecture of a robot requires, in particular at each new version of the algorithm executed by the computer, a validation step, by means of situation-tests.

During a test, the algorithm is executed by the computer implanted on the robot when the latter is placed in a real environment. This real environment, for example in the case of a mobile robot consists of a circuit including a test track along which are positioned obstacles. This configuration has the purpose of testing a particular functionality of the robot. The different characteristic data of the behavior of the robot during the execution by the computer of the algorithm are collected either by onboard sensors (whether these are native sensors of the robot or additional sensors with which the robot is specifically equipped during the test), or by sensors placed in the environment (observation camera for example).

At the end of the tests, the different collected data are brought back onto a workstation, and then synchronized in space and in time, before being analyzed with the purpose of evaluating the performances of the architecture to be validated.

This validation step in a situation requires a substantial time for implementation, notably for fitting out the robot with additional sensors for collecting specific data allowing validation of the architecture to be validated, for moving the equipped robot on the site of the test, for preparing a suitable environment, for carrying out the tests, and for returning and a posteriori synchronizing the collected data with view to their analysis.

Further, a test generally allows evaluation of the performances of the architecture to be evaluated according to a single pre-established scenario, the environment then being prepared according to this scenario. The tests must then be multiplied, by introducing different experimental conditions (such as modification of the slipping between the wheels of the robot and the ground, modification of the ambient illumination, etc.), if the intention is to exhaustively test the behavior of the robot and in particular the different functionalities of the architecture to be validated. This is not only lengthy, but is not always possible. Indeed, certain functionalities may not be tested, since the actual environment required for this validation would be too complicated or costly to produce.

Therefore there is a need for simplifying this step for validating the software and hardware architecture of a robot, while improving the validation level.

The object of the invention is therefore to address the aforementioned problem.

For this, the object of the invention is a simulation platform for validating a device including a programmed computer for executing an algorithm, said device being intended to be loaded on board a robot and connected to a sensor of the robot for receiving a measurement signal and to an actuator of the robot in order to transmit a control signal to it, the platform being intended to be connected to the computer and including a specific computation means for executing the instructions of a simulation program including:
a module for configuring an environment in three dimensions, in order to generate a virtual three-dimensional environment;
a module for simulating a response of the sensor of the robot, designed so as to generate output data corresponding to simulated measurement signals, from modeling of the behavior of the sensor of the robot and of input data formed by the generated virtual environment and by computed cinematic quantities of the robot, said simulated measurement signals being applied at the input of the computer of the device;
a module for simulating dynamics of the robot, designed for computing cinematic quantities of the robot, from modeling of the actuator of the robot and from input data corresponding to characteristic dynamic parameters of the robot, to the control signals transmitted by the computer of the device and to the generated virtual environment,

characterized in that the simulation program further includes a module for ordering in time, including:
a logic clock delivering the current logic instant;
an ordering scheme, associating with each logic instant a set of actions to be carried out;
a sub-module for calling upon a specific simulation action to be started, at the current logic instant delivered by the logic clock and depending on the whole of the actions associated with this current logic instant by the ordering scheme, the carrying out of a simulation action corresponding to the execution of the simulation module of the response of the sensor or of the simulation module of dynamics of a robot; and,
a sub-module for calling upon a reaction action of the robot, able to start at the current logic instant delivered by the logic clock and depending on the whole of the actions associated with this current logic instant by the ordering scheme, the carrying out of a response action of the robot corresponding to the processing by the computer of the device, of simulated measurement signals applied at the input of the computer at the current logic instant, for generating control signals at the current logic instant.

According to particular embodiments, the platform includes one or more of the following features, taken individually or according to all the technically possible combinations:
a sub-module for simulating the actuator of the robot, including modeling of the actuator of the robot; and,
a sub-module for computing cinematic and dynamic quantities, able to compute cinematic and dynamic quantities of the robot at the current logic instant from data at the output of the module for simulating the response of the actuator of the robot and from cinematic and dynamic quantities of the robot at the previous instant;
the calling sub-module is able to transmit a suitable control signal intended for the computer of the device, so as to synchronize the clock of the computer in order to clock the execution of the algorithm;
a suitable input/output interface in order to allow connection of said platform to a plurality of devices to be validated, each device being intended to be loaded on board a corresponding robot, the platform including, associated with each device, and therefore with each robot, a pair of modules consisting of a module for simulating a response of a sensor of said robot and a module for simulating the dynamics of said robot.

The object of the invention is also a simulation method for validation of a device including a programmed computer for executing an algorithm, said device being intended to be loaded on board a robot and to be connected to a sensor of the robot for receiving a measurement signal and to an actuator of the robot for transmitting to it a control signal,

characterized in that, as said method is applied on a simulation platform as defined above connected to said computer of the device, the method consists of:
generating a virtual three dimensional environment with which interacts said robot;
simulating a response of the sensor of the robot for generating output data corresponding to simulated measurement signals, from modeling of the behavior of the sensor of the robot and from input data formed by the generated virtual environment and by computed cinematic quantities of the robot, said simulated measurement signals being applied at the input of the computer of the device;
simulating dynamics of the robot for computing cinematic quantities of the robot, from modeling of the actuator of the robot and from input data corresponding to characteristic dynamic parameters of the robot, to control signals transmitted by the computer of the device and to the generated virtual environment,
ordering in time the calling of an action by starting, at the current logic instant delivered by the logic clock and depending on the whole of the actions associated with this current logic instant by an ordering scheme, the carrying out of a simulation action corresponding to the execution of the module for simulating the response of the sensor or of the simulation module of dynamics of the robot and by starting, at the current logic instant delivered by the logic clock and depending on the whole of the actions associated with this current logic instant by the ordering scheme, the carrying out of a response action of the robot corresponding to the processing by the computer of the device, of simulated measurement signals applied at the input of the computer at the current logic instant, for generating control signals at the current logic instant.

According to a particular embodiment:
applying at the input of the computer a simulated measurement signal, a data of which is compatible with the current logic instant;
synchronizing the clock of the computer governing the execution of the algorithm by transmitting at the current instant a suitable control signal by the platform intended for the computer; and,
dating the control signals generated at the output of the computer with a date corresponding to the current logic instant increased by the processing time of the computer.

Other features and advantages of the invention will become more clearly apparent from the detailed description which follows, given as an indication and being by no means limiting, and made with reference to the drawings, wherein:

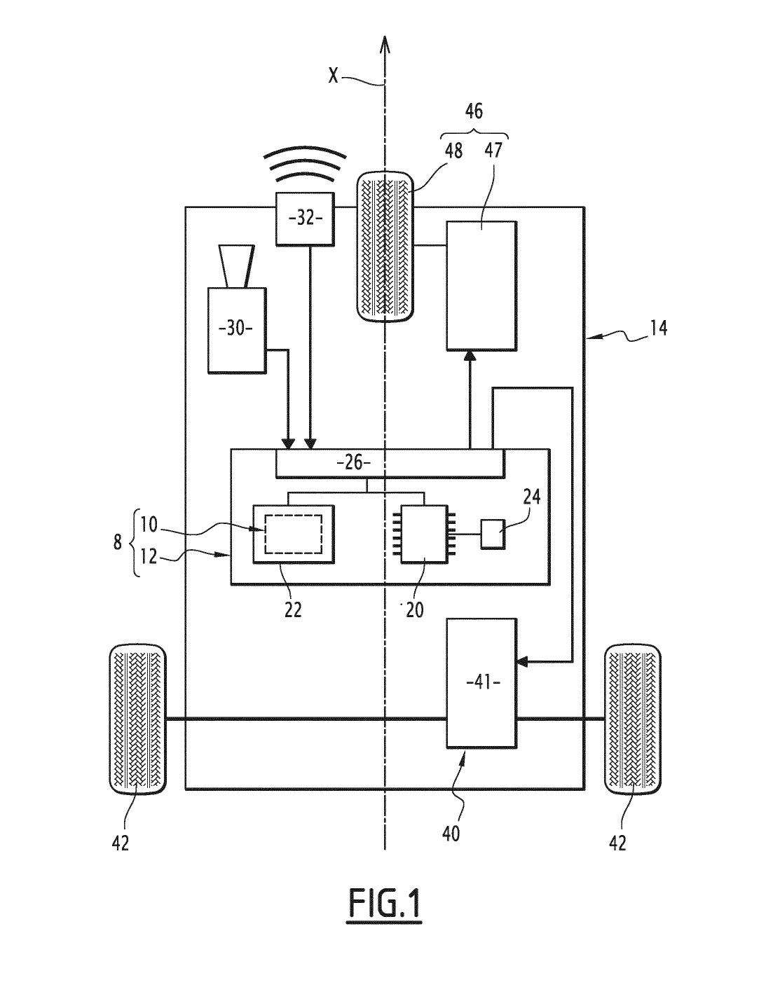

FIG. 1 is a schematic illustration of a mobile robot comprising a software and hardware architecture;

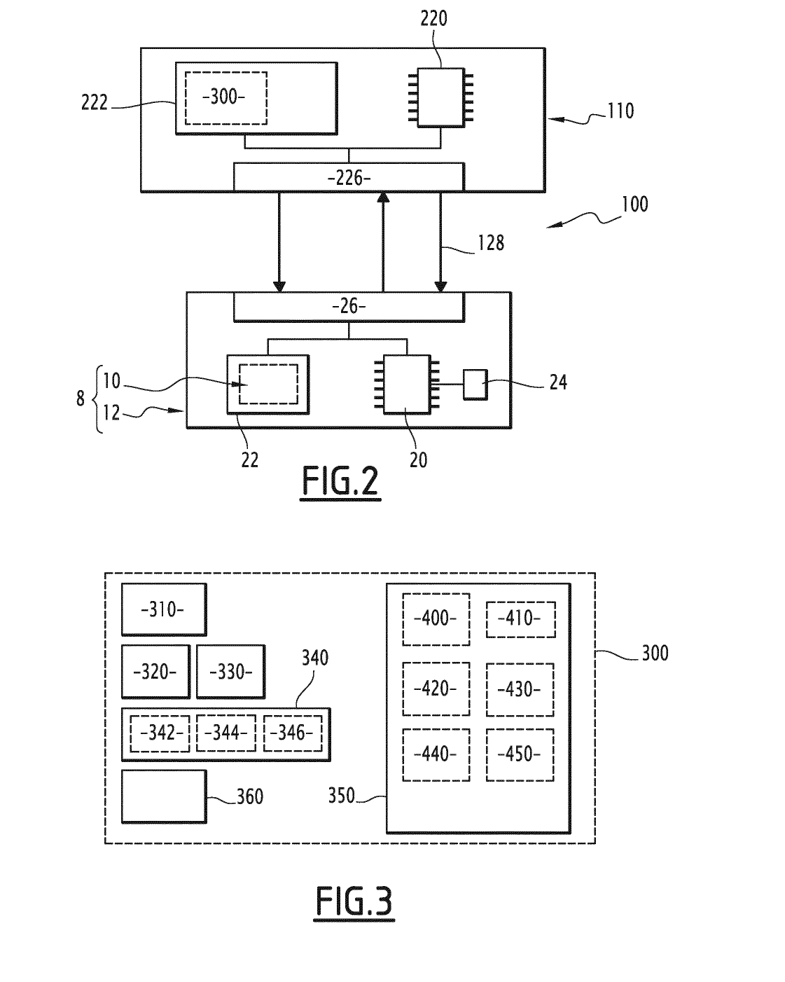

FIG. 2 is an illustration in the form of blocks of a system including a simulation platform and a device to be validated belonging to the architecture of the robot of FIG. 1;

FIG. 3 is a schematic illustration of the simulation program executed by the platform of FIG. 2; and,

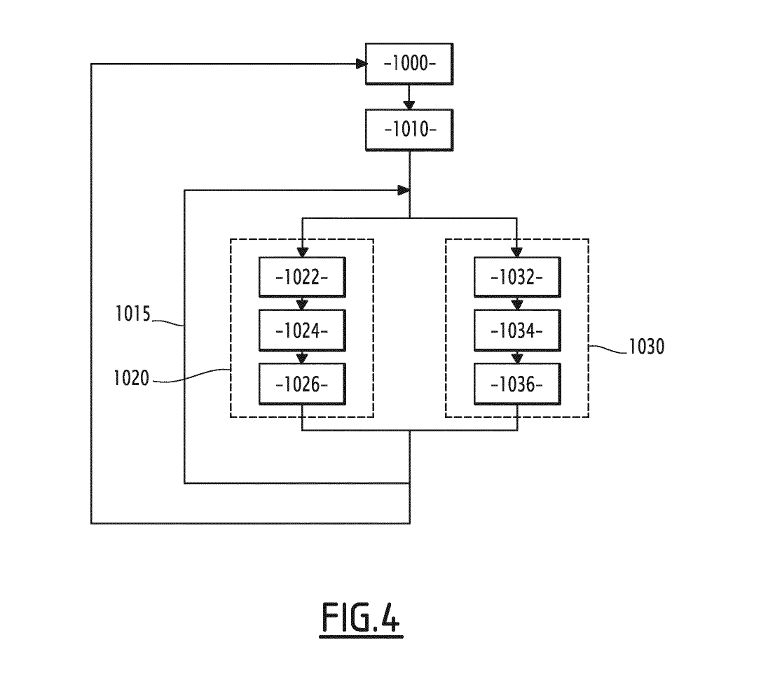

FIG. 4 is an illustration of the simulation method applied during the execution of the simulation program of FIG. 3.

In the following, the term of “device to be validated” designates the subset including a computer and an algorithm executed by the computer, intended to be integrated into the hardware and software architecture of the robot.

With reference to FIG. 1, the object of the invention is to facilitate validation of a device to be validated 8 intended to be loaded on board a robot 14.

In the particular embodiment described hereafter, the robot 14 is mobile, but in another embodiment, it may be a jointed manipulation or welding arm, etc.

The device 8 consists in a programmed computer 12 for applying an algorithm 10.

The computer 12 includes a processor 20, a memory 22, a clock 24, and an input/output interface 26 for connecting the computer 12 to external peripherals belonging to the hardware layer of the architecture of the robot 14.

The instructions of the algorithm 10 are stored in the memory 22 and are executed by the processor 20.

The robot 14 is equipped with at least one sensor forming an input peripheral able to apply a measurement signal at the input of the interface 26 of the computer 12.

In the present embodiment, the robot 14 is equipped with a first sensor 30 consisting in a fixed camera relatively to the robot so that its optical axis coincides with the longitudinal direction X of the robot. This camera is able to periodically generate (i.e. with a first period) a first measurement signal corresponding to a two dimensional picture of the observed environment. The camera is characterized by a set of parameters, such as a response time (separating the instant of incidence of a light ray on the objective of the camera and the transmission instant by the camera of the corresponding measurement signal), an acquisition frequency, a resolution, an observation range of wavelengths, an aperture of the observation field, etc.

The robot 14 is equipped with a second sensor 32 consisting in a laser range finder, fixed relatively to the robot, able to emit a laser pulse along the longitudinal direction X of the robot and to collect the energy reflected by the environment of the robot, so as to periodically generate (i.e. with a second period which is possibly different from that of the first sensor) a measurement signal corresponding to a distance along the longitudinal direction between the robot and an element of the scene (such as an obstacle). The range finder is characterized by a set of second parameters, such as a response time (separating the emission instant of a laser pulse and the generation of the corresponding measurement signal), an acquisition frequency, a defined resolution such as the angular pitch between two successive acquisitions, an observational range of wavelengths, etc.

The robot 14 is equipped with at least one actuator forming an output peripheral and capable of receiving a control signal transmitted at the output of the interface 26 of the computer 12.

In the present application, the term of << actuator >> is taken in the broadest sense. It groups the electronic processing and regulation chain allowing from a control signal, generation of a set value signal; the electric power supply means of the actuator allowing, from the set value signal, application of electric power to means for driving the actuator; the means for driving the actuator allowing, from the applied electric power, generation of mechanical power for displacing mechanical parts of the actuator; and the mechanical parts of the actuator.

In the present embodiment, the robot 14 is equipped with a first actuator 40 consisting in a propulsion system including a pair of driving wheels 42 and an electric motor 41 able to drive the wheels 42 into rotation. This first actuator is characterized by a set of parameters such as a response time between the reception of the control signal and the modification of the speed of rotation of the wheels.

The robot 14 is equipped with a second actuator 46 consisting in a steering system including a steered wheel 48 and an electric motor 47 able to modify the angle of the plane of the wheel 48 relatively to the longitudinal direction X of the robot. This second actuator is characterized by a set of parameters such as a response time between the reception of the control signal and the modification of the orientation of the steered wheel 46 relatively to the longitudinal axis of the robot.

The computer 12 is clocked by the clock 24 at a characteristic operating period, for example 10 ms. I.e., every 10 ms, the computer 12 processes the first and second measurement signals which are applied at the input of the interface 26 and transmits first and second control signals at the output of the interface 26.

Now referring to FIG. 2, the validation system 100 includes a platform 110 and the device to be validated 8.

Generally, the platform 110 includes a hardware layer and a software layer. The platform 110 includes a computation means, such as a microprocessor 220, a memory storage means, such as a memory 222, and an input/output interface 226.

The microprocessor 222 is able to execute the instructions of a simulation program 300 which are stored in the memory 222.

Each connector of the input/output interface 26 of the computer 12 is connected, through a suitable connection, to a mating connector of the input/output interface 226 of the platform 110.

As will be described below, the platform 110 is able, by replacing the sensors of the robot, to apply at the input of the computer 12 simulated measurement signals. The platform 110 is then able, by replacing the actuators of the robot, to receive at the output of the computer 12 the control signals generated by the computer 12 and which result from the processing of the simulated measurement signals.

The execution of the algorithm 10 by the processor 20 of the computer 12 is clocked by a clock signal transmitted by the clock 24. The transmission of this clock signal is controlled by a control signal generated by the platform 110 and applied to the clock 24 via a specific control connection, marked with the FIG. 128 in FIG. 2, between the interface 226 and the interface 26.

As schematically illustrated in FIG. 3, the simulation program 300 includes a configuration module 310, first and second modules, 320 and 330, for simulating the response of the first and second sensors 30 and 32 respectively, a module for simulating the dynamics of the robot 340 and a time ordering module 350.

The configuration module 310 is designed so as to allow a user to generate a virtual three dimensional environment inside which the robot is virtually immersed and with which the latter interacts virtually. The module 310 allows generation of a graphic representation in three dimensions of the environment (including the texture of the elements, realistic rendering of the shade and dazzle phenomena, etc.), as well as a physical representation of the elements of the environment (adherence coefficient for a road, hardness for an obstacle, reflection coefficient of the waves of the range finder for a wall, etc.). The module 310 is also designed for allowing configuration of the modelings used for each of the simulation modules and sub-modules.

The first module 320 is able to simulate the response of the first sensor 30. It is designed in order to generate a first simulated measurement signal, from modeling of the behavior of the first sensor 30 of the robot (modeling integrating the different characteristic parameters of the first sensor) and from input data formed by the virtual environment which was generated by means of the module 310 and of the instantaneous cinematic quantities of the robot delivered by the module 340.

Similarly, the second module 330 is able to simulate the response of the second sensor 32 of the robot. The module 330 is designed so as to generate a second simulated measurement signal, from modeling of the behavior of the second sensor 32 (modeling integrating the different characteristic parameters of this second sensor) and from input data formed by the virtual environment which was generated and instantaneous cinematic quantities of the robot.

The module for simulating the dynamics of the robot 340 is able to simulate the dynamic behavior of the robot. The module 340 is designed for computing the instantaneous cinematic and dynamic quantities of the robot. The module 340 includes a first sub-module for simulating the response of the first actuator 342, a second sub-module for simulating the response of the second actuator 344, and a sub-module 346 for computing cinematic and dynamic quantities.

The first sub-module 342 is able to simulate the response of the first actuator 40 of the robot. The sub-module 342 is designed so as to generate at the output a first set of dynamic data at the current instant, from modeling of the first actuator 40 (modeling integrating the different characteristic parameters of this first actuator), from input data formed by the virtual environment which was generated by means of the module 310 and from a first control signal transmitted by the computer at the current instant.

Similarly, the second sub-module 344 is able to simulate the response of the second actuator 46 of the robot. The sub-module 344 is designed for generating a second set of dynamic data at the current instant, from modeling of the second actuator 46 (modeling integrating the different characteristic parameters of this second actuator), from input data formed by the virtual environment which was generated and from a second control signal transmitted by the computer at the current instant.

The sub-module 346 is able to compute the values of the cinematic and dynamic quantities of the robot at the current instant from modeling of the dynamics of the robot and from first and second sets of dynamic data at the current instant delivered at the output of the first and second sub-modules for simulating the response of an actuator, 342 and 344, and cinematic and dynamic quantities of the robot at the previous instant.

The program 300 includes a time ordering module 350 able to handle all the data generated by the module or sub-module of the program 300 so as to guarantee their time consistency in order to simulate the real time interaction between the robot and the environment.

More specifically, the module 350 is able to control the instant for performing an action whether this is a simulation action, defined as the execution of a module from among the modules 320, 330 and 340 of the platform 110, or an action of reaction of the robot, defined as the execution of the algorithm 10 by the computer 12 for processing the measurement signals.

In particular, the module 350 is designed for dating the data generated during the carrying out of an action.

For this, the time ordering module 350 includes an ordering scheme 400, a logic clock 410, a sub-module for managing a logic clock 420, a reading sub-module of the ordering scheme 430, a calling sub-module for a simulation action 440 and a sub-module for calling an action of reaction of the robot 450.

The ordering scheme 400 consists in a table indicating the schedule for performing the different actions. More specifically, the scheme 400 associates with each instant a list of actions to be carried out.

The time interval between two successive instants of the ordering scheme 400 is less than the shortest period characterizing the different elementary processes applied on the robot 14. This time interval of the ordering scheme is selected so that there exists an integer multiple number giving the possibility of passing from this time interval to each of the repetition frequencies. For example, if the characteristic period of operation of the computer 12 of the robot is 10 ms, the response time of the first sensor 30 is 5 ms with a repetition period of 10 ms, the response time of the second sensor 32 is 20 ms with a repetition period of 20 ms, the response time of the first actuator 40 is 5 ms and the response time of the second actuator 46 is 4 ms, the time interval of the ordering scheme will for example be selected to 1 ms.

A logic clock 410 is an integer variable. Each unit of the logic clock corresponds to an instant of the ordering scheme 400. The current value of the logic clock gives the current logic instant.

The sub-module for managing the logic clock 420 is designed for incrementing the logic clock 410 by one unit. The sub-module 420 is called when all the actions associated in the scheme 400 with the current logic instant have been carried out. After incrementation of the clock by one unit, the management sub-module 420 is able to call the reading sub-module 430.

The reading sub-module 430 is designed for reading the current logic instant, delivered by the logic clock 410, and then for reading the ordered scheme 400 for determining the actions to be executed at the current logic instant.

If the action is a simulation action corresponding to the execution of a module of the platform 110, the reading sub-module 430 starts the sub-module for calling upon a simulation action 440 by indicating to it the simulation module to be executed.

On the other hand, if the action is an action of reaction of the robot, corresponding to the execution of the algorithm 10 by the computer 12, the reading sub-module 430 starts the sub-module for calling upon an action of reaction of the robot 450.

The sub-module for calling upon a simulation action 440 is able to start the execution of the simulation module which is indicated to it. The sub-module 440 applies at the input of the required simulation module, input data, the data of which is compatible with the current logic instant.

At the end of the execution of the required simulation module, the sub-module 440 is able to date the data generated at the output of the required simulation module, with a date corresponding to the current logic instant.

The dated data are stored in the memory 222 of the platform 110 for subsequent use as input data of another simulation module or of the algorithm 10.

The sub-module for calling upon an action of reaction of the robot 450 is designed for applying on the interface 26 of the computer 12, simulated measurement signals which have been generated by the modules for simulating the response of the sensors, 320, 330, and the date of which meets a compatibility criterion with the current logic instant.

This compatibility criterion consists for example in a time interval separating the date of generation of the data of the current logic instant, less than a predetermined duration. This predetermined duration corresponds to the theoretical duration for carrying out the simulated process by the simulation module having generated the data. Thus, for the simulation module of the first sensor, this theoretical duration is 5 ms, for the simulation module of the second sensor, 20 ms, etc.

The sub-module 450 is also able to synchronize the clock 24 of the computer 12 so that the latter resumes execution of the algorithm 10. For this, the sub-module 450 transmits a control signal via the connection 128, to the computer 12 which then resumes execution of the algorithm 10.

The execution of the algorithm 10 leads to the processing of the measurement signals which at the current instant are applied to the input of the interface 26 of the computer 12 and to the generation of control signals on the output of the interface 26 of the computer 12.

At the end of the processing of the measurement signals and upon generation of control signals, the operation of the processor 22 is suspended until a subsequent control signal is received, i.e. after a logical duration of 10 ms.

The sub-module 450 is able to date the data generated at the output of the computer 12 with the date corresponding to the current logic instant increased by the duration for generating the control signals with the computer 12 on the interface 26. This duration corresponds to the processing time of the computer 12 between reception of the measurement signals on the interface 26 and the transmission of the control signals on the interface 26. The thereby dated control signals are stored in the memory 222 in order to be able to be used as input data by a module for simulating the response of an actuator, 342 or 344.

Advantageously, the simulation program 300 also includes a follow up module 360 able to deliver, for each logic instant, the cinematic and dynamic data of the robot, the data stemming from sensors of the robot or from virtual sensors placed in the environment (such as parameterizable cameras for observing the scene). The module 360 allows a user to follow the course of the test with a suitable elapse of time. In particular, the user may select a real time course, the time interval between two successive logic instants then being equal to the time of a real clock.

With reference to FIG. 4, the simulation method consists in the succession of the following steps:

In step 1000 for incrementing the clock, the logic clock management sub-module 420 increments the logic clock 410 by one unit and then calls the reading sub-module 430.

In step 1010 for reading the current logic instant and of the ordering scheme, the reading sub-module 430 reads the current logic instant, delivered by the logic clock 410, and then reads the ordering scheme 400 for determining the different actions to be performed at the current logic instant.

The method then enters a loop 1015 for successively processing each action which has to be carried out at the current instant.

If the action to be carried out corresponds to a simulation action, the sub-module 440 is started while indicating to it the simulation module to be executed.

In step 1020 for calling a simulation module, the sub-module 440 carries out the following elementary steps:

In step 1022 for applying dated data, the sub-module 440 applies at the input of the required simulation module, data for which the validity date is compatible with the current logic instant.

In step 1024 for executing the indicated module, the sub-module 440 starts the execution of the required simulation module.

In step 1026 for dating the generated data, the sub-module 440 dates the generated data at the output of the executed simulation module, with a date corresponding to the current logic instant.

The dated data are stored in the memory 222 of the platform 110 for subsequent use as input data for a simulation module or for the algorithm 10.

On the other hand, if the action to be carried out corresponds to an action of reaction of the robot, the sub-module 450 is started.

In step 1030 for executing the algorithm 10, the sub-module 450 carries out the following elementary steps:

In step 1032 for applying dated signals, the sub-module 450 applies on the interface 26 of the computer 12, simulated measurement signals which have been generated at the output of the modules for simulation of the response of the sensors, 320, 330, and for which the date is compatible with the current logic instant.

In step 1034 for transmitting the control signal of the clock of the computer, the sub-module 450 applies a control signal able to synchronize the clock 24 of the computer 12 so that the latter resumes execution of the algorithm 10.

The execution of the algorithm 10 then leads to the processing of measurement signals applied at the input of the interface 26 of the computer 12 and to the transmission of control signals on the output of the interface 26 of the computer 12.

Finally, in step 1036 for dating control signals, the sub-module 450 dates the control signals generated at the output of the computer 12 with a date corresponding to the current logic instant increased by the duration for generating the control signals by the computer 20. This duration corresponds to the processing time of the computer 12 between reception of the signals applied at the input of the interface 26 and the transmission of the control signals on the interface 26.

The thereby dated control signals are stored in the memory 222 in order to be able to be used by a module for simulating the response of an actuator, 342 or 344.

Once all the actions to be carried out for the current logic instant have been performed, the method exits from the loop 1015 and returns to step 1000 where the clock management module 420 increments by one unit the clock 410 in order to switch to the next logic instant on the scheme 400.

In the present embodiment, the platform 110 is intended for the test of the behavior of a single device to be validated. A single computer 12 is thus servo-controlled by the platform. Alternatively, the platform allows the simultaneous test of N devices to be validated corresponding to N robots simultaneously moving in a same environment, a robot forming an actor of the environment perceived by another robot. For this, N computers are connected to the simulation platform which therefore includes a suitable input/output interface. The platform then includes, associated with each device to be validated and with the corresponding robot, a pair of modules consisting of a module for simulating a response of said or each sensor of the robot and a module for simulating the dynamics of the robot.

Alternatively, the platform allows the test of a device to be validated corresponding to a first robot intended to move in an environment including a second robot. For this the platform is suitable for simulating the behavior of the second robot.

In the present embodiment, the platform 110 is intended for the test of the behavior of a robot equipped with a camera and a range finder. Alternatively, the platform allows the test of a robot equipped with any type of sensor known to one skilled in the art.

In still another alternative independent of the previous ones, the device to be validated includes a man/machine interface for exchanging data with an operator.

It should be noted that the breaking down into modules of the embodiment shown in detail is specific to this embodiment. Other breaking-down schemes may be contemplated. One skilled in the art will know how to apply the invention in a context including another distribution of the simulation modules.

In the embodiment shown in detail, the device to be validated includes the computer which will actually be implanted on the robot. Alternatively, the device to be validated includes a computer similar to the one which will be implanted in the robot. The question is then to validate the algorithm rather than the computer executing the algorithm. In an advantageous embodiment, the computer is simplified. In particular, it includes a simpler interface than the one of the computer loaded on board the robot. This simplified interface allows exchange of the same data with the platform, but reconditioned by software in order to modify the type thereof.

In the present description, for the sake of clarity, a single algorithm is executed by a computer including a single processor. One skilled in the art will understand that the platform according to the invention allows validation of any type of software and hardware architecture of the robot: several algorithms being simultaneously executed on one or several partitions of the hardware layer of the computer of the robot; several processors operating in parallel; a distributed architecture of the algorithm to be validated, etc.

Preferably, the platform according to the invention assumes the form of a single casing having suitable connections for subordinating one or several devices to be validated and, advantageously, for connecting an interface means allowing a user to configure the platform and to collect the data from a virtual test.

The simulation platform is a practical, realistic and rapid testing tool. It advantageously facilitates prototyping of the hardware and software architecture of a robot (computers, sensors, actuators, etc.) from a specification.

1-6. (canceled)

7. A simulation platform (110) for validating a device including a programmed computer (12) for executing an algorithm (10), said device being intended to be loaded on board a robot and to be connected to a sensor (30, 32) of the robot for receiving a measurement signal and to an actuator (40, 46) of the robot for transmitting to it a control signal, the platform being intended to be connected to the computer and including a computing means able to execute the instructions of a simulation program (300) including:
a module for configuring a three-dimensional environment (310), for generating a virtual three-dimensional environment;
a module for simulating a response of the sensor of the robot (320, 330), for generating output data corresponding to simulated measurement signals, from modeling of the behavior of the sensor of the robot and from input data formed by the generated virtual environment and by computed cinematic quantities of the robot, said simulated measurement signals being applied at the input of the computer of the device;
a module for simulating dynamics of the robot (340), for computing cinematic quantities of the robot, from modeling of the actuator of the robot and from input data corresponding to characteristic dynamic parameters of the robot, to control signals transmitted by the computer of the device and to the generated virtual environment,
characterized in that the simulation program further includes a module for ordering in time (350), including:
a logic clock (410) delivering the current logic instant;
an ordering scheme (400), associating with each logic instant a set of actions to be carried out;
a sub-module for calling upon a simulation action (440) able to start, at the current logic instant delivered by the logic clock and depending on the whole of the actions associated with this current logic instant by the ordering scheme, the carrying out of a simulation action corresponding to the execution of the module for simulating the response of the sensor or of the module for simulating dynamics of a robot; and,
a sub-module for calling upon an action of reaction of the robot (450), starting, at the current logic instant delivered by the logic clock and depending on the whole of the actions associated with this current logic instant by the ordering scheme, the carrying out of a response action of the robot corresponding to the processing by the computer of the device, of simulated measurement signals applied at the input of the computer at the current logic instant, for generating control signals at the current logic instant.

8. The platform according to claim 7, wherein the module for simulating dynamics of the robot (340) includes:
a sub-module (342, 344) for simulating the actuator of the robot, including modeling of the actuator (40, 46) of the robot; and,
a sub-module for computing cinematic and dynamic quantities (346) able to compute cinematic and dynamic quantities of the robot at the current logic instant from data at the output of the module for simulating the response of the actuator of the robot and from cinematic and dynamic quantities of the robot at the previous instant.

9. The platform according to claim 7, wherein the calling sub-module (450) transmits a suitable control signal to the computer of the device, so as to synchronize the clock (24) of the computer (12) in order to clock the execution of the algorithm (10).

10. The platform according to claim 7, including a suitable input/output interface in order to allow connection of said platform to a plurality of devices to be validated, each device being intended to be on board a corresponding robot, the platform including, associated with each device, and therefore with each robot, a pair of modules consisting of a module for simulating a response of a sensor of said robot and a module for simulating the dynamics of said robot.

11. A simulation method for validating a device including a programmed computer (12) for executing an algorithm (10), said device being intended to be loaded on board a robot and to be connected to a sensor (30, 32) of the robot for receiving a measurement signal and to an actuator (40, 46) of the robot for transmitting to it a control signal,
characterized that, as said method is applied on a simulation platform (110) according to claim 7, connected to said computer of the device, the method consists of:
generating a virtual three-dimensional environment with which interacts said robot;
simulating a response of the sensor of the robot for generating output data corresponding to simulated measurement signals, from modelling of the behaviour of the sensor of the robot and from input data formed by the generated virtual environment and by computed cinematic quantities of the robot, said simulated measurement signals being applied at the input of the computer of the device;
simulating dynamics of the robot for computing cinematic quantities of the robot, from modeling of the actuator of the robot and from input data corresponding to characteristic dynamic parameters of the robot, to control signals transmitted by the computer of the device and to the generated virtual environment,
ordering in time the call to an action by starting, at the current logic instant delivered by a logic clock and depending on the whole of the actions associated with this current logic instant by an ordering scheme, the carrying out of a simulation action corresponding to the execution of the module for simulating the response of the sensor or of the module for simulating dynamics of the robot or by starting, at the current logic instant delivered by the logic clock and depending on the whole of the actions associated with this current logic instant by the ordering scheme, the carrying out of a response action of the robot corresponding to the processing by the computer of the device, of simulated measurement signals applied at the input of the computer at the current logic instant, for generating control signals at the current logic instant.

12. The method according to claim 11, wherein the starting of a response action of the robot includes:
applying at the input of the computer (12) a simulated measurement signal, one date of which is compatible with the current logic instant;
synchronizing the clock (24) of the computer (12) governing execution of the algorithm (10) by transmitting at the current instant a suitable control signal by the platform to the computer; and,
dating the control signals generated at the output of the computer with a date corresponding to the current logic instant increased by the processing time of the computer (12).

13. A simulation method for validating a device including a programmed computer (12) for executing an algorithm (10), said device being intended to be loaded on board a robot and to be connected to a sensor (30, 32) of the robot for receiving a measurement signal and to an actuator (40, 46) of the robot for transmitting to it a control signal,
characterized that, as said method is applied on a simulation platform (110) according to claim 8, connected to said computer of the device, the method consists of:
generating a virtual three-dimensional environment with which interacts said robot;
simulating a response of the sensor of the robot for generating output data corresponding to simulated measurement signals, from modelling of the behaviour of the sensor of the robot and from input data formed by the generated virtual environment and by computed cinematic quantities of the robot, said simulated measurement signals being applied at the input of the computer of the device;
simulating dynamics of the robot for computing cinematic quantities of the robot, from modeling of the actuator of the robot and from input data corresponding to characteristic dynamic parameters of the robot, to control signals transmitted by the computer of the device and to the generated virtual environment,
ordering in time the call to an action by starting, at the current logic instant delivered by a logic clock and depending on the whole of the actions associated with this current logic instant by an ordering scheme, the carrying out of a simulation action corresponding to the execution of the module for simulating the response of the sensor or of the module for simulating dynamics of the robot or by starting, at the current logic instant delivered by the logic clock and depending on the whole of the actions associated with this current logic instant by the ordering scheme, the carrying out of a response action of the robot corresponding to the processing by the computer of the device, of simulated measurement signals applied at the input of the computer at the current logic instant, for generating control signals at the current logic instant.

14. A simulation method for validating a device including a programmed computer (12) for executing an algorithm (10), said device being intended to be loaded on board a robot and to be connected to a sensor (30, 32) of the robot for receiving a measurement signal and to an actuator (40, 46) of the robot for transmitting to it a control signal,
characterized that, as said method is applied on a simulation platform (110) according to claim 9, connected to said computer of the device, the method consists of:
generating a virtual three-dimensional environment with which interacts said robot;
simulating a response of the sensor of the robot for generating output data corresponding to simulated measurement signals, from modelling of the behaviour of the sensor of the robot and from input data formed by the generated virtual environment and by computed cinematic quantities of the robot, said simulated measurement signals being applied at the input of the computer of the device;
simulating dynamics of the robot for computing cinematic quantities of the robot, from modeling of the actuator of the robot and from input data corresponding to characteristic dynamic parameters of the robot, to control signals transmitted by the computer of the device and to the generated virtual environment,
ordering in time the call to an action by starting, at the current logic instant delivered by a logic clock and depending on the whole of the actions associated with this current logic instant by an ordering scheme, the carrying out of a simulation action corresponding to the execution of the module for simulating the response of the sensor or of the module for simulating dynamics of the robot or by starting, at the current logic instant delivered by the logic clock and depending on the whole of the actions associated with this current logic instant by the ordering scheme, the carrying out of a response action of the robot corresponding to the processing by the computer of the device, of simulated measurement signals applied at the input of the computer at the current logic instant, for generating control signals at the current logic instant.

15. A simulation method for validating a device including a programmed computer (12) for executing an algorithm (10), said device being intended to be loaded on board a robot and to be connected to a sensor (30, 32) of the robot for receiving a measurement signal and to an actuator (40, 46) of the robot for transmitting to it a control signal,
characterized that, as said method is applied on a simulation platform (110) according to claim 10, connected to said computer of the device, the method consists of:
generating a virtual three-dimensional environment with which interacts said robot;
simulating a response of the sensor of the robot for generating output data corresponding to simulated measurement signals, from modelling of the behaviour of the sensor of the robot and from input data formed by the generated virtual environment and by computed cinematic quantities of the robot, said simulated measurement signals being applied at the input of the computer of the device;
simulating dynamics of the robot for computing cinematic quantities of the robot, from modeling of the actuator of the robot and from input data corresponding to characteristic dynamic parameters of the robot, to control signals transmitted by the computer of the device and to the generated virtual environment,
ordering in time the call to an action by starting, at the current logic instant delivered by a logic clock and depending on the whole of the actions associated with this current logic instant by an ordering scheme, the carrying out of a simulation action corresponding to the execution of the module for simulating the response of the sensor or of the module for simulating dynamics of the robot or by starting, at the current logic instant delivered by the logic clock and depending on the whole of the actions associated with this current logic instant by the ordering scheme, the carrying out of a response action of the robot corresponding to the processing by the computer of the device, of simulated measurement signals applied at the input of the computer at the current logic instant, for generating control signals at the current logic instant.
